(19) United States
(12) Patent Application Publication
(10) Pub. No.: US 2010/0013975 A1
(43) Pub. Date: Jan. 21, 2010

(54) IMAGE SENSOR

(75) Inventors: Hayato Nakashima, Anpachi-gun (JP); Ryu Shimizu, Mizuho-shi (JP); Mamoru Arimoto, Ogaki-shi (JP); Kaori Misawa, Kaizu-shi (JP)

Correspondence Address: DITTHAVONG MORI & STEINER, P.C., 918 Prince Street, Alexandria, VA, 22314, US

(73) Assignee: Sanyo Electric Co., Ltd., Moriguchi-shi (JP)

(21) Appl. No.: 12/501,867

(22) Filed: Jul. 13, 2009

(30) Foreign Application Priority Data
Jul. 15, 2008 (JP) 2008-183847

(51) Int. Cl. H04N 5/335

(52) U.S. Cl. 348/308; 348/E05.091

(57) ABSTRACT

This image sensor includes a charge transfer region transferring signal charge, a transfer electrode formed on the surface of the charge transfer region through a first insulating film, an increasing portion provided on the charge transfer region for increasing the signal charge and a transistor, provided on a region other than the charge transfer region, having a second insulating film smaller in thickness than the first insulating film.

### CROSS-REFERENCE TO RELATED APPLICATIONS

The priority application number JP2008-183847, Image Sensor, Jul. 15, 2008, Hayato Nakashima, Ryu Shimizu, Mamoru Arimoto, Kaori Misawa, upon which this patent application is based is hereby incorporated by reference.

### BACKGROUND OF THE INVENTION

1. Field of the Invention

The present invention relates to an image sensor, and more particularly, it relates to an image sensor including an increasing portion for increasing signal charge.

2. Description of the Background Art

An image sensor including an increasing portion for increasing the number of electrons (signal charge) is known in general.

A CMOS image sensor including a charge transfer region transferring electrons (signal charge) and an increasing portion provided on the charge transfer region for impact-ionizing electrons thereby increasing the number thereof is disclosed in general. In the conventional CMOS image sensor, gate insulating films having constant thicknesses are formed with respect to a transfer gate electrode of the charge transfer region and a gate electrode of a transistor provided on a region other than the charge transfer region.

### SUMMARY OF THE INVENTION

An image sensor according to an aspect of the present invention includes a charge transfer region transferring signal charge, a transfer electrode formed on the surface of the charge transfer region through a first insulating film, an increasing portion provided on the charge transfer region for increasing the signal charge and a transistor, provided on a region other than the charge transfer region, having a second insulating film smaller in thickness than the first insulating film.

In the image sensor according to the aspect of the present invention, the withstand voltage of the increasing portion can be increased while operating the transistor provided on the region other than the charge transfer region at a high speed, due to the aforementioned structure.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view showing the overall structure of an image sensor according to a first embodiment of the present invention;

FIG. 2 is a sectional view of an imaging region and a peripheral logic circuit region provided on the image sensor according to the first embodiment;

FIG. 3 is a circuit diagram of the imaging region provided on the image sensor according to the first embodiment;

FIG. 4 is a plan view of a single pixel provided on the image sensor according to the first embodiment;

FIG. 5 is a potential diagram for illustrating an electron transferring operation in the imaging region provided on the image sensor according to the first embodiment;

FIG. 6 is a potential diagram for illustrating an electron multiplying operation in the imaging region provided on the image sensor according to the first embodiment;

FIG. 7 is a sectional view for illustrating a pixel region in an image sensor according to a second embodiment of the present invention;

FIG. 8 is a sectional view for illustrating a pixel region in an image sensor according to a third embodiment of the present invention;

FIG. 9 is a sectional view for illustrating a pixel region in an image sensor according to a fourth embodiment of the present invention;

FIG. 10 is a sectional view for illustrating a pixel region in an image sensor according to a fifth embodiment of the present invention;

FIG. 11 is a sectional view for illustrating a pixel region in an image sensor according to a sixth embodiment of the present invention; and

FIG. 12 is a sectional view for illustrating a modification of the present invention.

### DESCRIPTION OF THE PREFERRED EMBODIMENTS

Embodiments of the present invention are now described with reference to the drawings.

### First Embodiment

A first embodiment of the present invention is applied to an active CMOS image sensor, which is an exemplary image sensor.

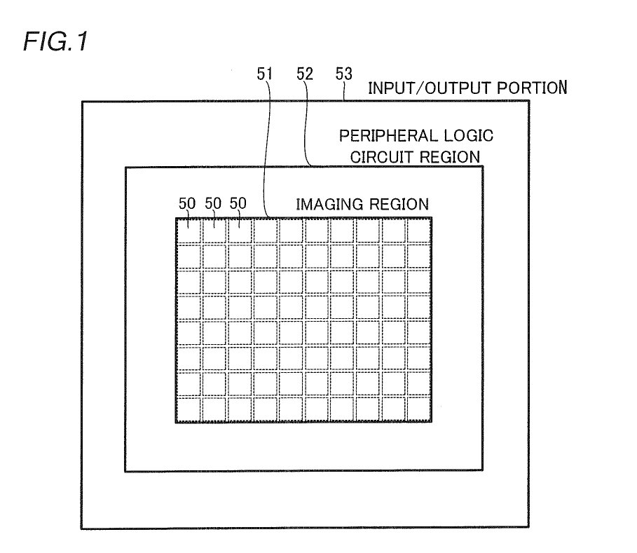

As shown in FIG. 1, the CMOS image sensor according to the first embodiment of the present invention is constituted of a chip including an imaging region 51 including a plurality of pixels 50 arranged in the form of a matrix, a peripheral logic circuit region 52 formed on the periphery of the imaging region 51 and an input/output portion 53. The peripheral logic circuit region 52 is provided with circuits for analog-to-digital conversion and image processing, for example. The input/output portion 53 is provided with a protective circuit and a pad (electrode) which is a connecting portion for a substrate (not shown), for example.

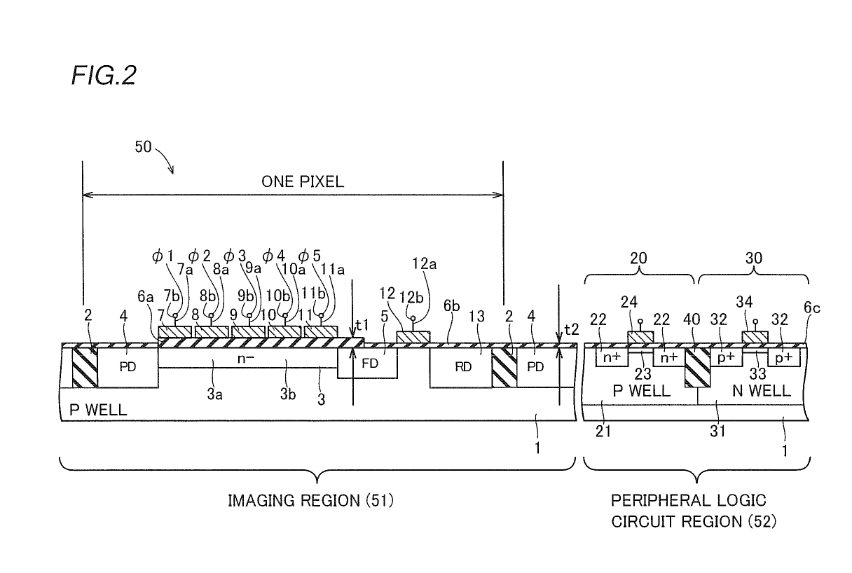

As to the sectional structure of each pixel 50 of the CMOS image sensor, an element isolation region 2 for isolating the pixel 50 is formed on the surface of a p-type well region 1 formed on the surface of an n-type silicon substrate (not shown), as shown in FIG. 2. On the surface of the portion of the p-type well region 1 provided with the pixel 50 surrounded by the element isolation region 2, a photodiode portion (PD portion) 4 and a floating diffusion region (FD region) 5 consisting of an n-type impurity region are formed at a prescribed interval from each other to hold a transfer channel 3 consisting of an n⁻-type impurity region therebetween. The PD portion 4 is an example of the “photoelectric conversion portion” in the present invention.

The PD portion 4 has a function of generating electrons in response to the quantity of incident light and storing the generated electrons. The PD portion 4 is formed to be adjacent to the element isolation region 2 as well as to the transfer channel 3. The FD region 5 has a function of holding signal charge resulting from transferred electrons and converting the signal charge to voltage. The CMOS image sensor is so formed as to detect signal voltage by detecting the voltage converted by the FD region 5. The FD region 5 is formed to be adjacent to the transfer channel 3. Thus, the FD region 5 is formed to be opposed to the PD portion 4 through the transfer channel 3. The transfer channel 3 is an example of the “charge transfer region” in the present invention. The FD region 5 is an example of the “charge detecting portion” in the present invention.

A first insulating film 6a consisting of a thermal silicon oxide film (SiO₂ film) formed by thermally oxidizing the surface of a silicon (Si) substrate (the surface of the transfer channel 3) and functioning as a gate insulating film is formed on the surface of the transfer channel 3. The first insulating film 6a has a thickness t1 of about 60 nm.

A transfer gate electrode 7, a multiplier gate electrode 8, another transfer gate electrode 9, a storage gate electrode 10 and a read gate electrode 11 are formed on the surface of the first insulating film 6a in this order from the side of the PD portion 4 toward the side of the FD region 5. The transfer gate electrode 7 is formed between the PD portion 4 and the multiplier gate electrode 8. The read gate electrode 11 is formed between the storage gate electrode 10 and the FD region 5. The read gate electrode 11 is formed to be adjacent to the FD region 5. The transfer gate electrode 7 is an example of the “transfer electrode” or the “first transfer electrode” in the present invention. The multiplier gate electrode 8 is an example of the “increasing electrode” in the present invention. The transfer gate electrode 9 is an example of the “transfer electrode” or the “second transfer electrode” in the present invention. The storage gate electrode 10 is an example of the “transfer electrode” or the “storage electrode” in the present invention. The read gate electrode 11 is an example of the “transfer electrode” or the “read electrode” in the present invention.

An electron multiplier portion 3a is provided on a portion of the transfer channel 3 located under the multiplier gate electrode 8, while an electron storage portion 3b is provided on a portion of the transfer channel 3 located under the storage gate electrode 10. The electron multiplier portion 3a is an example of the “increasing portion” in the present invention.

A reset gate electrode 12 is formed on a position opposed to the read gate electrode 11 through the FD region 5. A reset drain region (RD region) 13 is formed on a position holding the reset gate electrode 12 between the same and the FD region 5. A second insulating film 6b functioning as a gate insulating film of the reset gate electrode 12 is formed on the surface of the p-type well region 1. The transfer gate electrode 7, the multiplier gate electrode 8, the transfer gate electrode 9, the storage gate electrode 10, the read gate electrode 11 and the reset gate electrode 12 are constituted of single gate structures formed through the same process. The second insulating film 6b is an example of the “gate insulating film” in the present invention.

According to the first embodiment, the second insulating film 6b is so formed that the thickness thereof is smaller than that of the first insulating film 6a formed on the surface of the transfer channel 3. More specifically, the first insulating film 6a is formed to have the thickness t1 of about 60 nm, while the second insulating film 6b is formed to have a thickness t2 of not more than about 7 nm. The boundary between the first insulating film 6a and the second insulating film 6b is arranged on a central portion of the FD region 5. The second insulating film 6b provided on the RD region 13 is formed up to a region (a position substantially identical to the boundary between the PD portion 4 and the transfer channel 3 of an adjacent pixel 5) reaching the surface of the PD portion 4 of the adjacent pixel 5.

Wiring layers 7b, 8b, 9b, 10b and 11b supplying clock signals Φ1, Φ2, Φ3, Φ4 and Φ5 for voltage control are electrically connected to the transfer gate electrode 7, the multiplier gate electrode 8, the transfer gate electrode 9, the storage gate electrode 10 and the read gate electrode 11 through contact portions 7a, 8a, 9a, 10a and 11a respectively. The wiring layers 7b, 8b, 9b, 10b and 11b are formed every row, and electrically connected to the transfer gate electrodes 7, the multiplier gate electrodes 8, the transfer gate electrodes 9, the storage gate electrodes 10 and the read gate electrodes 11 of all pixels 50 of the corresponding row respectively.

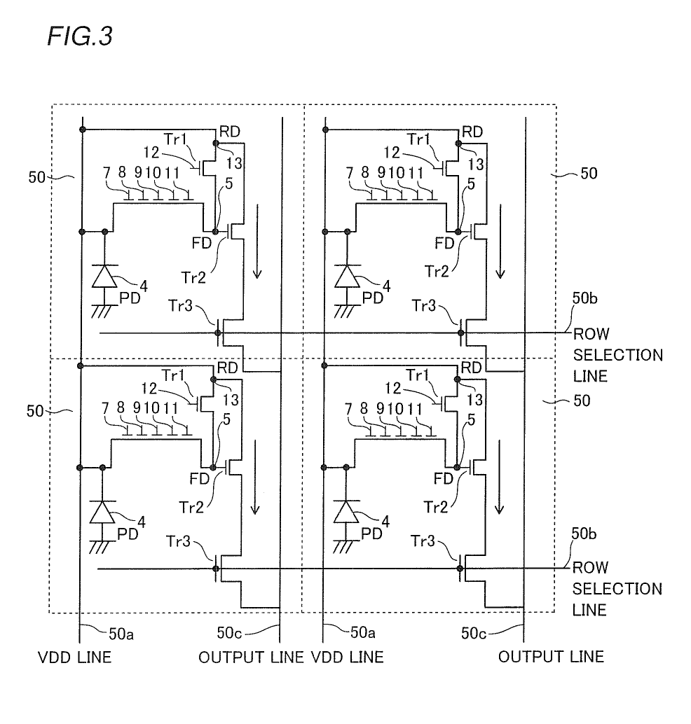

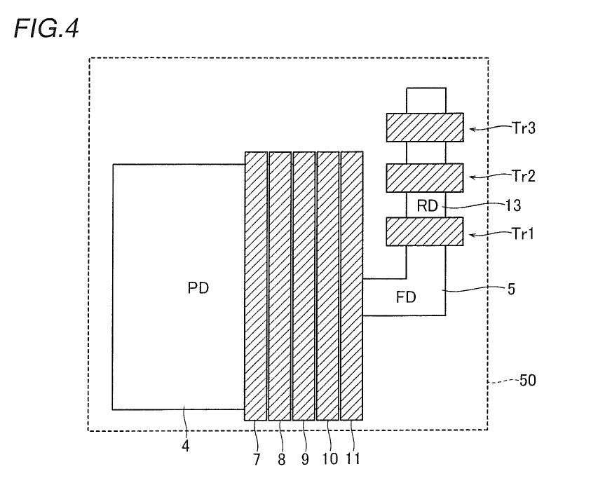

As shown in FIGS. 3 and 4, each pixel 50 includes the transfer gate electrode 7, the multiplier gate electrode 8, the transfer gate electrode 9, the storage gate electrode 10 and the read gate electrode 11, a reset transistor Tr1 including the reset gate electrode 12, an amplifier transistor Tr2 and a selection transistor Tr3.

A reset gate line 12b is connected to the reset gate electrode 12 of the reset transistor Tr1 through a contact portion 12a (see FIG. 2), so that a reset signal is supplied thereto. The RD region 13 functions as the drain of the reset transistor Tr1, and is connected to a power supply voltage (VDD) line 50a. The FD region 5 functions as the source of the reset transistor Tr1 and the drain of the read gate electrode 11, and is connected to the gate of the amplifier transistor Tr2. The source of the selection transistor Tr3 is connected to the drain of the amplifier transistor Tr2. A row selection line 50b and an output line 50c are connected to the gate and the drain of the selection transistor Tr3 respectively. The second insulating film 6b (see FIG. 2) functions also as the gate insulating film of the transistor Tr2 and Tr3, in addition to that of the transistor Tr1. The reset transistor Tr1, the amplifier transistor Tr2 and the selection transistor Tr3 are examples of the “transistor” in the present invention.

The CMOS image sensor according to the first embodiment is so formed as to amplify a signal with the amplifier transistor Tr2 in each pixel 50, due to the aforementioned circuit structure. Further, the CMOS image sensor is so formed as to on-off control the read gate electrodes 11 every row while simultaneously on-off controlling the gate electrodes 7 to 10 other than the read gate electrodes 11 of all pixels 50.

As shown in FIG. 2, a peripheral logic circuit consisting of an N-type MOS transistor 20, a P-type MOS transistor 30 and the like is formed on the peripheral logic circuit region 52 of the CMOS image sensor. As to a specific sectional structure, a p-type well region 21 and an n-type well region 31 are formed on the surface of the p-type well region 1. An element isolation region 40 is formed between the p-type well region 21 and the n-type well region 31. N⁺-type impurity regions 22 functioning as a source and a drain respectively are formed on the p-type well region 21, while a transfer region 23 is formed between the impurity regions 22. A gate electrode 24 is formed on the transfer region 23 through a third insulating film 6c, thereby constituting the N-type MOS transistor 20. Similarly, p⁺-type impurity regions 32 are formed on the n-type well region 31, while a transfer region 33 is formed between the impurity regions 32. A gate electrode 34 is formed on the transfer region 33 through the third insulating film 6c, thereby constituting the P-type MOS transistor 30. The gate electrodes 24 and 34 of the transistors 20 and 30 provided on the peripheral logic circuit region 52 can be formed through the same process as that for the gate electrodes 7 to 11 provided in the imaging region 51. The third insulating film 6c is an example of the “gate insulating film” in the present invention.

According to the first embodiment, the third insulating film 6c has the thickness t2 of not more than about 7 nm, similarly to the second insulating film 6b.

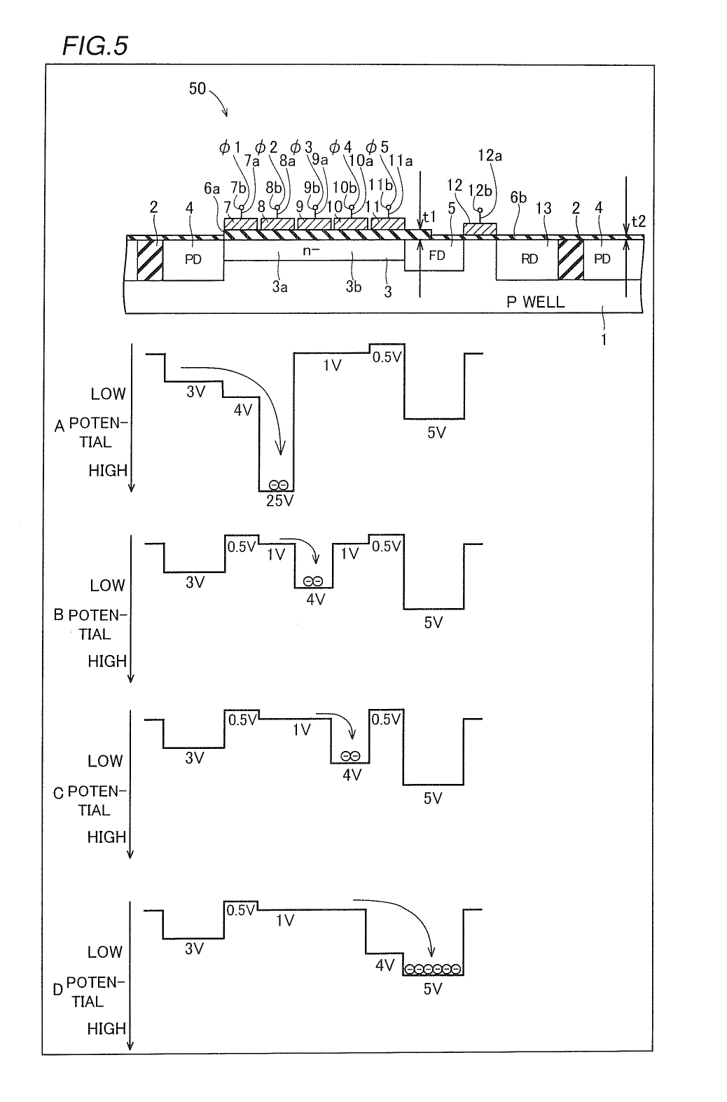

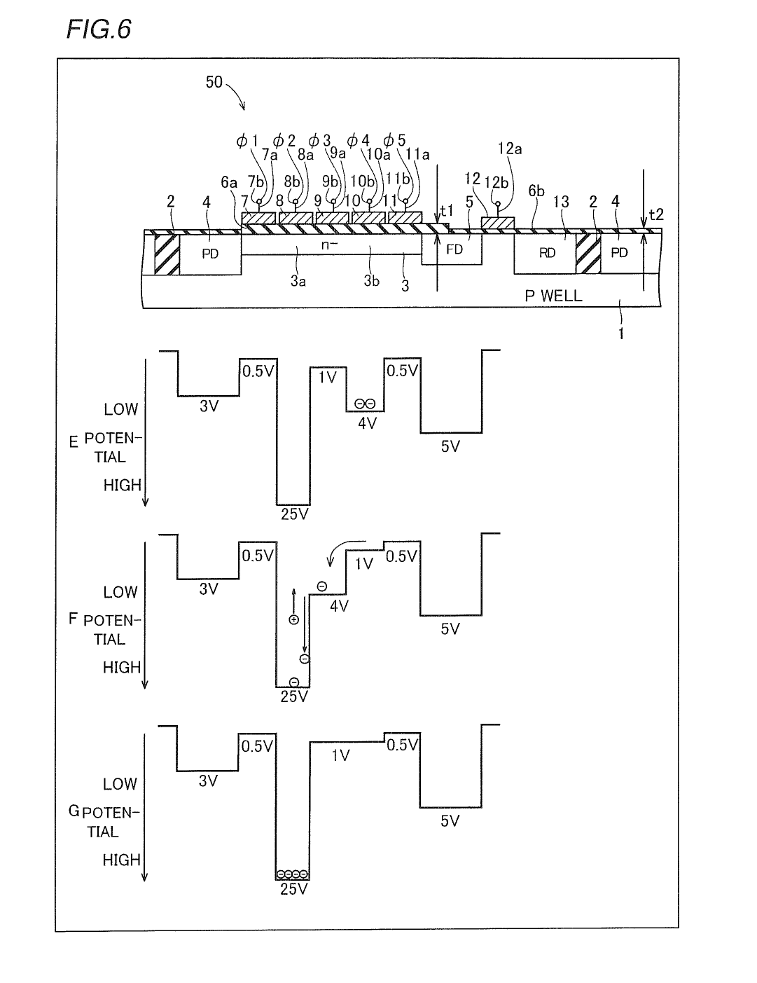

FIGS. 5 and 6 are potential diagrams for illustrating an electron transferring operation and an electron multiplying operation in each pixel 50 provided on the CMOS image sensor according to the first embodiment of the present invention.

First, the electron transferring operation is described. When light is incident upon the PD portion 4, electrons are generated in the PD portion 4 by photoelectric conversion, as shown in FIG. 5. In a period A shown in FIG. 5, the electrons generated by the PD portion 4 are transferred to the portion of the transfer channel 3 located under the multiplier gate electrode 8 having a higher potential through the transfer gate electrode 7. The electrons are transferred to a portion of the transfer channel 3 located under the transfer gate electrode 9 in a period B, and transferred to the portion (electron storage portion 3b) of the transfer channel 3 located under the storage gate electrode 10 in a period C. Thereafter the electrons are transferred up to the FD region 5 through the read gate electrode 11 in a period D.

The electron multiplying operation is now described. The electron multiplying operation is performed in a portion of the transfer channel 3 located between the multiplier gate electrode 8 and the storage gate electrode 10. More specifically, the electron multiplying operation is performed in periods E, F and G shown in FIG. 6, following the period when the electrons are held in the portion of the transfer channel 3 located under the storage gate electrode 10. In other words, the potential of the electron multiplier portion 3a located under the multiplier gate electrode 8 is adjusted to about 25 V in the period E, and the potential of the portion of the transfer channel 3 located under the transfer gate electrode 9 is adjusted to about 4 V in the period F. Thereafter the potential of the electron multiplier portion 3b located under the storage gate electrode 10 is adjusted to about 1 V, whereby electrons stored in the electron storage portion 3b are transferred to the electron multiplier portion 3a (potential: about 25 V) located under the multiplier gate electrode 8 through the portion (potential: about 4 V) of the transfer channel 3 located under the transfer gate electrode 9. Thus, the electrons are multiplied. Then, the transfer gate electrode 9 is turned off in the period G, whereby the electron multiplying operation is completed. The aforementioned electron transferring operation is so performed from this state that the multiplied electrons are transferred to the FD region 5. In the electron multiplying operation, the potentials of the portions of the transfer channel 3 located under the transfer gate electrode 7 and the read gate electrode 11 respectively are so adjusted to about 0.5 V that the electrons can be inhibited from moving toward the PD portion 4 and toward the FD region 5.

The electron transferring operation between the electron multiplier portion 3a and the electron storage portion 3b is performed a plurality of times (about 400 times, for example), whereby the electrons transferred from the PD portion 4 are multiplied to about 2000 times. Signal charge resulting from the electrons multiplied and stored in the aforementioned manner is read as a voltage signal through the FD region 5 due to the aforementioned read operation.

According to the first embodiment, as hereinabove described, the thickness t2 of the second insulating film 6b provided on the region other than that provided with the transfer channel 3 is rendered smaller than the thickness t1 of the first insulating film 6a formed on the surface of the transfer channel 3 in the imaging region 51 so that the second insulating film 6b functioning as the gate insulating film of the transistors Tr1, Tr2 and Tr3 formed on the region provided with the second insulating film 6b is smaller in thickness than the first insulating film 6a, whereby the transistors Tr1, Tr2 and Tr3 can be operated at a higher speed as compared with the electron transferring operation in the transfer channel 3. Further, the first insulating film 6a formed on the portion of the transfer channel 3 provided with the electron multiplier portion 3a is rendered larger in thickness than the second insulating film 6b, whereby the withstand voltage of the electron multiplier portion 3a subjected to application of high voltage can be increased. Therefore, voltage for increasing the number of electrons can be easily applied to the electron multiplier portion 3a, whereby the number of the electrons can be increased by a desired multiplying factor. Thus, an image of higher quality can be obtained while implementing high-speed operations.

According to the first embodiment, as hereinabove described, the boundary between the first insulating film 6a and the second insulating film 6b is so provided on the surface of the FD region 5 that an electron transfer path can be inhibited from generation of dark current. On the boundary between the first insulating film 6a and the second insulating film 6b having different thicknesses, a crystal defect is easily formed in the substrate due to film stress, to disadvantageously result in generation of dark current. Therefore, if the boundary between the first insulating film 6a and the second insulating film 6b is provided on the transfer channel 3, for example, dark current generated in the portion of the transfer channel 3 located immediately under the boundary is disadvantageously multiplied by the aforementioned electron multiplying operation. Further, if the boundary between the first insulating film 6a and the second insulating film 6b is provided on the PD portion 4, for example, noise disadvantageously results from the aforementioned dark current. According to the first embodiment, however, the boundary between the first insulating film 6a and the second insulating film 6b is provided on the surface of the FD region 5, whereby the aforementioned disadvantages such as multiplication of the dark current and generation of noise can be suppressed. While dark current is generated in the FD region 5 similarly to the above when the boundary between the first insulating film 6a and the second insulating film 6b is provided on the surface of the FD region 5, the CMOS image sensor according to the first embodiment is so formed as to initialize the potential of the FD region 5 by operating the reset transistor Tr1 immediately before transferring the electrons to the FD region when reading signal charge, and can read the signal charge with no influence exerted by the dark current generated in the FD region 5.

According to the first embodiment, as hereinabove described, the boundary between the first insulating film 6a and the second insulating film 6b is so provided on the surface of the FD region 5 that dispersion of characteristics can be suppressed. If the boundary (step) between the first insulating film 6a and the second insulating film 6b is provided in the vicinity of an end portion of the read gate electrode 11 closer to the FD region 5 or in the vicinity of an end portion of the transfer channel 3, for example, the characteristics may change following changes in the thicknesses of the gate insulating films to result in dispersion of the signal charge in the electron transferring operation performed by the transfer channel 3 and the electron multiplying operation performed by the electron multiplier portion 3a. Also when the thicknesses of the gate insulating films change in the vicinity of an end portion of the reset gate electrode 12, a reset operation may be dispersed. According to the aforementioned structure, therefore, dispersion of the characteristics can be suppressed in both of the transfer channel 3 and the reset gate electrode 12. Even if the boundary between the first insulating film 6a and the second insulating film 6b slightly deviates from the central portion of the FD region 5 toward an end portion, the boundary is arranged to be closer to the central portion than the end portion of the FD region 5, whereby the same is not provided in the vicinity of the end portion of the read gate electrode 11 or the transfer channel 3, dissimilarly to the above. Therefore, the thickness t1 of the first insulating film 6a provided under the transfer gate electrode 7, the multiplier gate electrode 8, the transfer gate electrode 9, the storage gate electrode 10 and the read gate electrode 11 and the thickness t2 of the second insulating film 6b provided as the gate insulating film of the transistors Tr1, Tr2 and Tr3 formed in the imaging region 51 and the transistors 20 and 30 provided on the peripheral logic circuit region 52 can be set to desired values respectively.

According to the first embodiment, as hereinabove described, the CMOS sensor is constituted as the active CMOS image sensor including the reset transistor Tr1, the amplifier transistor Tr2 and the selection transistor Tr3 every pixel 50 and amplifying the signal with the amplifier transistor Tr2 every pixel 50 so that the same is hardly influenced by noise in a pixel data reading path when reading pixel data, whereby reduction in image quality can be suppressed as compared with a passive CMOS image sensor.

According to the first embodiment, as hereinabove described, the third insulating film 6c functioning as the gate insulating film of the transistors (the N-type MOS transistor 20 and the P-type MOS transistor 30) arranged on the peripheral logic circuit region 52 formed on the periphery of the imaging region 51 also has the small thickness (t2) similarly to the second insulating film 6b, whereby the transistors 20 and 30 arranged on the peripheral logic circuit region 52 can be operated at a high speed similarly to the reset transistor Tr1 formed in the pixel 50 and driven at a similar voltage level. According to the first embodiment, all of the transistors Tr1, Tr2 and Tr3 formed in the pixel 50 and the transistors 20 and 30 provided on the peripheral logic circuit region 52 can be driven with voltage of about 3.3 V. Further, the second insulating film 6b and the third insulating film 6c having the same thickness t2 can be formed through the same process.

According to the first embodiment, as hereinabove described, the first insulating film 6a is constituted of a thermal silicon oxide film. If a gate insulating film is formed by a silicon nitride film, for example, the silicon nitride film may trap multiplied electrons, to result in multiplication deterioration. According to the aforementioned structure, such multiplication deterioration can be suppressed.

According to the first embodiment, as hereinabove described, the boundary between the first insulating film 6a and the second insulating film 6b is provided on the position substantially identical to the boundary between the PD portion 4 and the transfer channel 3, whereby the thickness of the second insulating film 6b formed on the surface of the PD portion 4 is rendered constant. Thus, the magnitude of parasitic capacitance resulting from the second insulating film 6b formed on the PD region 4 can be rendered constant in the PD region 4.

According to the first embodiment, as hereinabove described, the transfer gate electrode 7, the multiplier gate electrode 8, the transfer gate electrode 9, the storage gate electrode 10 and the read gate electrode 11 are provided on the surface of the first insulating film 6a, whereby the electrons can be repetitively multiplied in the portions of the transfer channel 3 located under the multiplier gate electrode 9, the transfer gate electrode 9 and the storage gate electrode 10. The transfer gate electrode 7 and the read gate electrode 11 are turned off during the electron multiplying operation, whereby the multiplied electrons can be inhibited from leaking toward the PD portion 4 or toward the FD region 5.

### Second Embodiment

In a CMOS image sensor according to a second embodiment of the present invention, the boundary between a first insulating film 6a and a second insulating film 6b is provided on an end portion of the surface of an FD region 5, dissimilarly to the CMOS image sensor according to the first embodiment so formed that the boundary between the first insulating film 6a and the second insulating film 6b is provided on the central portion of the surface of the FD region 5.

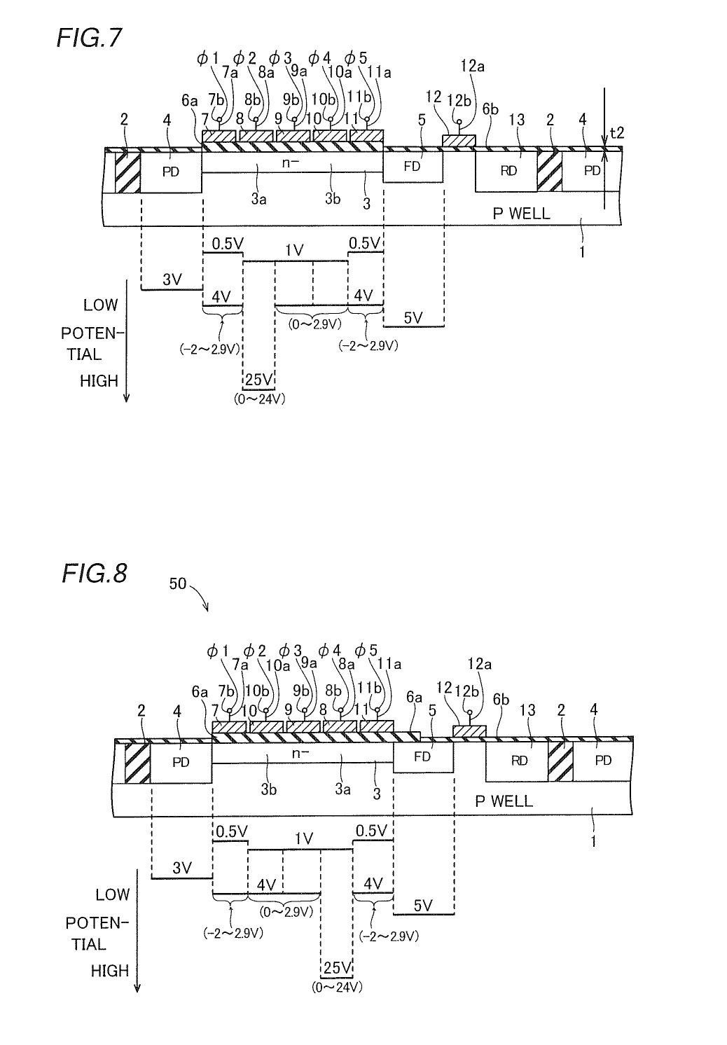

As shown in FIG. 7, the surface of the FD region 5 is covered with the second insulating film 6b. The boundary between the first insulating film 6a and the second insulating film 6b is provided on a position substantially identical to the boundary between a transfer channel 3 and the FD region 5.

The remaining structure and operations of the second embodiment are similar to those of the first embodiment.

According to the second embodiment, as hereinabove described, the boundary between the first insulating film 6a and the second insulating film 6b is provided on the position substantially identical to the boundary between the transfer channel 3 and the FD region 5, whereby the thickness of the insulating film formed on the FD region 5 is rendered constant. Thus, the magnitude of parasitic capacitance resulting from the insulating film formed on the FD region 5 can be rendered constant in the FD region 5, whereby dispersion in signal charge conversion efficiency resulting from a change (change in the thickness of the insulating film) in the parasitic capacitance in the FD region 5 can be suppressed.

The remaining effects of the second embodiment are similar to those of the first embodiment.

### Third Embodiment

In a CMOS image sensor according to a third embodiment of the present invention, an electron multiplier portion 3a and an electron storage portion 3b are provided on positions opposite to those in the structure according to the first embodiment.

As shown in FIG. 8, a storage gate electrode 10 is provided between transfer gate electrodes 7 and 9, while a multiplier gate electrode 8 is provided between the transfer gate electrode 9 and a read gate electrode 11. The electron storage portion 3b is provided on a portion of a transfer channel 3 located under the storage gate electrode 10, while the electron multiplier portion 3a is provided on a portion of the transfer channel 3 located under the multiplier gate electrode 8.

The remaining structure and operations of the third embodiment are similar to those of the first embodiment.

According to the third embodiment, the boundary between a first insulating film 6a and a second insulating film 6b is provided on a central portion of the surface of an FD region 5 also when the electron multiplier portion 3a is provided on the side of the read gate electrode 11 as hereinabove described, whereby dispersion in characteristics can be suppressed in both of the transfer channel 3 and the reset gate electrode 12.

According to the third embodiment, the electron multiplier portion 3a is provided on a position farther from a PD portion 4 as compared with the first embodiment when the electron multiplier portion 3a is provided on the side of the read gate electrode 11 as hereinabove described. When electrons are transferred from the PD portion 4, therefore, the number of the transferred electrons can be inhibited from dispersion resulting from high voltage generated in an electron multiplying operation.

The remaining effects of the third embodiment are similar to that of the first embodiment.

### Fourth Embodiment

In a CMOS image sensor according to a fourth embodiment of the present invention, neither a first insulating film 6a nor a second insulating film 6b is provided on the surface of an FD region 5.

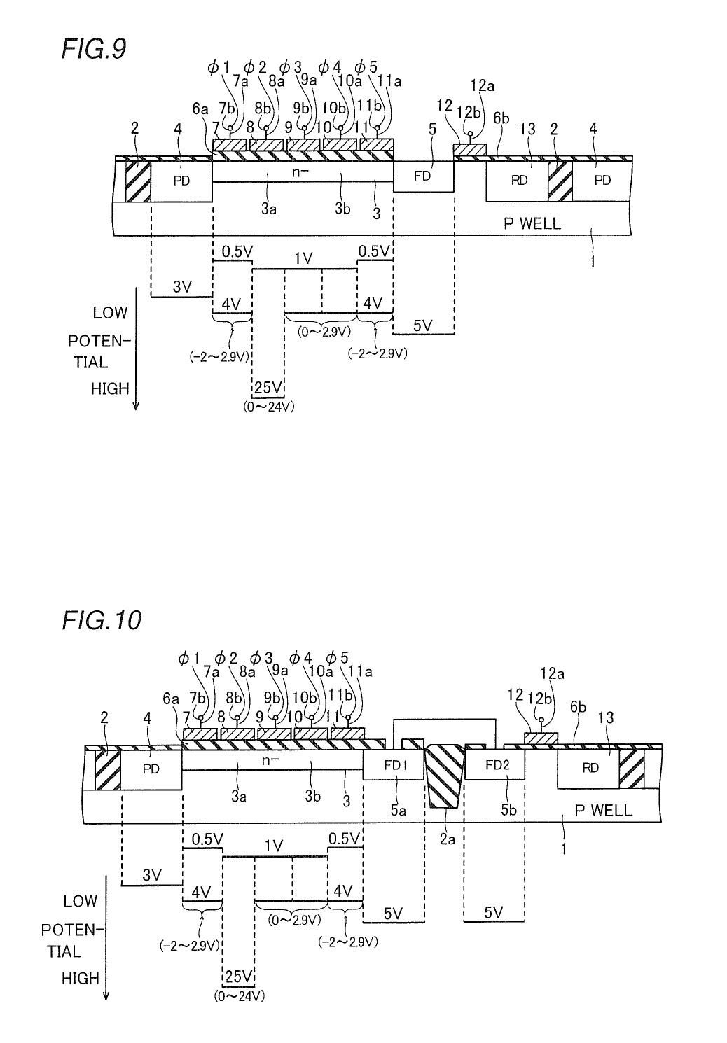

As shown in FIG. 9, neither the first insulating film 6a nor the second insulating film 6b is formed on the surface of the FD region 5, but an interlayer dielectric film (not shown) is arranged thereon.

The remaining structure and operations of the fourth embodiment are similar to those of the first embodiment.

According to the fourth embodiment, as hereinabove described, the interlayer dielectric film is arranged on the surface of the FD region 5 so that parasitic capacitance in the FD region 5 is increased when the dielectric constant of the interlayer dielectric film is higher than those of the first and second insulating films 6a and 6b, for example, whereby signal charge conversion efficiency in the FD region 5 is reduced to reduce sensitivity as a result. When the dielectric constant of the interlayer dielectric film is lower than those of the first and second insulating films 6a and 6b, on the other hand, the parasitic capacitance in the FD region 5 is reduced, whereby the signal charge conversion efficiency in the FD region 5 is increased to increase the sensitivity as a result. In this case, noise is rendered bigger while the sensitivity is increased. Thus, the structure according to the fourth embodiment can be applied to both of high- and low-sensitivity image sensors depending on the dielectric constant of the interlayer dielectric film provided on the FD region 5, and generation of noise can be controlled by controlling the dielectric constant of the interlayer dielectric film.

The remaining effects of the fourth embodiment are similar to those of the first embodiment.

### Fifth Embodiment

A CMOS image sensor according to a fifth embodiment of the present invention is provided with two FD regions.

As shown in FIG. 10, an FD1 region 5a is provided on a position of a p-type well region 1 adjacent to a transfer channel 3, while a first insulating film 6a is formed on the surface of the FD1 region 5a. An FD2 region 5b is formed on a position opposed to the FD1 region 5a through an element isolation region 2a, while a second insulating film 6b is formed on the surface of the FD2 region 5b. The first insulating film 6a is partially formed on the surface of the FD1 region 5a, while the second insulating film 6b is partially formed on the surface of the FD2 region 5b. The FD1 region 5a and the FD2 region 5b are electrically connected with each other in a region of the FD1 region 5a not provided with the first insulating film 6a and a region of the FD2 region 5b not provided with the second insulating film 6b. The FD1 region 5a and the FD2 region 5b are examples of the “first charge detecting portion” and the “second charge detecting portion” in the present invention respectively.

The remaining structure and operations of the fifth embodiment are similar to those of the first embodiment.

According to the fifth embodiment, as hereinabove described, the CMOS image sensor is provided with two FD regions, i.e., the FD1 region 5a adjacent to the transfer channel 3 and the FD2 region 5b adjacent to a reset gate electrode 12, whereby the first insulating film 6a is uniformly formed on the surface of the FD1 region 5a and the second insulating film 6b is uniformly formed on the surface of the FD2 region 5b. Therefore, parasitic capacitance resulting from the insulating film can be uniformized in each FD region, whereby dispersion in conversion efficiency can be suppressed. Consequently, the conversion efficiency of the FD regions (the FD1 region 5a and the FD2 region 5b) can be uniformized.

The remaining effects of the fifth embodiment are similar to those of the first embodiment.

### Sixth Embodiment

In a CMOS image sensor according to a sixth embodiment of the present invention, three gate electrodes are provided on the surface of a transfer channel 3.

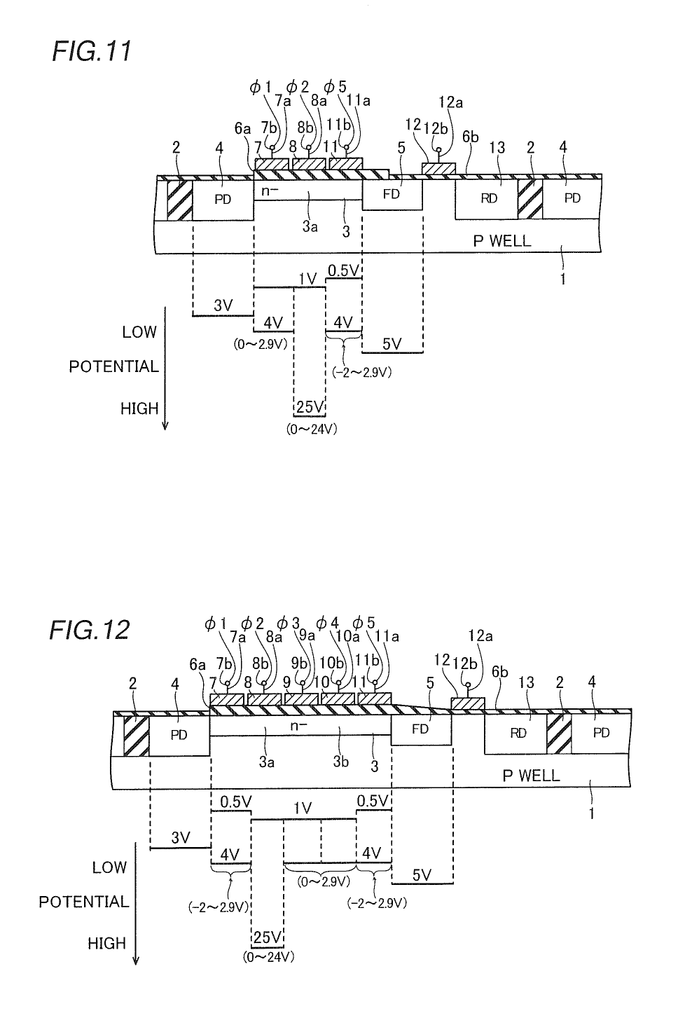

As shown in FIG. 11, a transfer gate electrode 7, a multiplier gate electrode 8 and a read gate electrode 11 are arranged on the transfer channel 3 in this order from a PD portion 4 toward an FD region 5. The CMOS image sensor is so formed as to multiply electrons by reciprocatively transferring the electrons between an electron multiplier portion 3a and the PD portion 4 in an electron multiplying operation. When an off signal Φ1 is supplied to the transfer gate electrode 7, voltage of about 0 V is applied to the transfer gate electrode 7, while a portion of the transfer channel 3 located under the transfer gate electrode 7 is adjusted to a potential of about 1 V.

The remaining structure and operations of the sixth embodiment are similar to those of the first embodiment.

According to the sixth embodiment, the boundary between a first insulating film 6a and a second insulating film 6b is provided on a central portion of the surface of the FD region 5 similarly to the first embodiment also when each pixel 50 is constituted of three gate electrodes, i.e., the transfer gate electrode 7, the multiplier gate electrode 8 and the read gate electrode 11 as hereinabove described, whereby dispersion in characteristics can be suppressed in both of the transfer channel 3 and a reset gate electrode 12.

The remaining effects of the sixth embodiment are similar to those of the first embodiment.

Although the present invention has been described and illustrated in detail, it is clearly understood that the same is by way of illustration and example only and is not to be taken by way of limitation, the spirit and scope of the present invention being limited only by the terms of the appended claims.

For example, while the active CMOS image sensor amplifying signal charge in each pixel is employed as the exemplary image sensor in each of the aforementioned first to sixth embodiments, the present invention is not restricted to this, but is also applicable to a passive CMOS image sensor not amplifying signal charge in each pixel.

While the first insulating film 6a is formed by the oxide film consisting of SiO₂ in each of the aforementioned first to sixth embodiments, the present invention is not restricted to this, but the first insulating film 6a may alternatively be formed by an insulating film consisting of a material other than SiO₂.

While the transfer channel 3, the PD portion 4 and the FD portion 5 are formed on the surface of the p-type well region 1 formed on the surface of the n-type silicon substrate (not shown) in each of the aforementioned first to sixth embodiments, the present invention is not restricted to this, but the transfer channel 3, the PD portion 4 and the FD region 5 may alternatively be formed on the surface of a p-type silicon substrate.

While the electrons are employed as the signal charge in each of the aforementioned first to sixth embodiments, the present invention is not restricted to this, but holes may alternatively be employed as the signal charge by entirely reversing the conductivity type of a substrate impurity and the polarity of applied voltage.

While the second insulating film 6b is formed on the surface of the PD portion 4 in each of the aforementioned first to sixth embodiments, the present invention is not restricted to this, but an insulating film other than the first and second insulating films 6a and 6b may alternatively be formed on the surface of the PD portion 4.

While the boundary between the first insulating film 6a and the second insulating film 6b is provided on the central portion of the surface of the FD region 5 in the aforementioned first embodiment, the present invention is not restricted to this, but insulating films may alternatively be provided to be inclined from an end portion of a first insulating film 6a toward an end portion of a second insulating film 6b (so that the thickness of the first insulating film 6a is gradually reduced) in an FD region 5, as shown in FIG. 12.

While the boundary between the first insulating film 6a and the second insulating film 6b is provided on the position similar to that of the boundary between the transfer channel 3 and the FD region 5 in the aforementioned second embodiment, the present invention is not restricted to this, but the boundary between the first insulating film 6a and the second insulating film 6b may alternatively be provided on the boundary between the FD region 5 and the reset gate electrode 12.

While the interlayer dielectric film is formed on the surface of the FD region 5 in the aforementioned fourth embodiment, the present invention is not restricted to this, but an insulating film, other than the interlayer dielectric film, having a dielectric constant different from those of the first and second insulating films 6a and 6b may alternatively be formed on the surface of the FD region 5.

What is claimed is:

1. An image sensor comprising:
a charge transfer region transferring signal charge;
a transfer electrode formed on the surface of said charge transfer region through a first insulating film;
an increasing portion provided on said charge transfer region for increasing said signal charge; and
a transistor, provided on a region other than said charge transfer region, having a second insulating film smaller in thickness than said first insulating film.

2. The image sensor according to claim 1, further comprising a charge detecting portion for detecting said signal charge as voltage, wherein
the boundary between said first insulating film and said second insulating film is provided on the surface of said charge detecting portion.

3. The image sensor according to claim 2, wherein
the boundary between said first insulating film and said second insulating film is provided on a central portion of the surface of said charge detecting portion along a direction from said charge transfer region toward said charge detecting portion.

4. The image sensor according to claim 2, wherein
said charge detecting portion is arranged to be adjacent to said charge transfer region, and
the boundary between said first insulating film and said second insulating film is provided on an end portion of the surface of said charge transfer region.

5. The image sensor according to claim 2, wherein
said transistor includes a reset transistor provided to be adjacent to said charge detecting portion for returning the potential of said charge detecting portion to an initial value.

6. The image sensor according to claim 1, further comprising a charge detecting portion for detecting said signal charge as voltage, wherein
said transistor includes a reset transistor provided to be adjacent to said charge detecting portion for returning the potential of said charge detecting portion to an initial value,
said charge detecting portion provided to be adjacent to said reset transistor constitutes one of source/drain regions of said reset transistor, and
said second insulating film is not formed on the surface of said charge detecting portion, but constitutes a gate insulating film of said reset transistor.

7. The image sensor according to claim 1, further comprising a charge detecting portion for detecting said signal charge as voltage, wherein
said transistor includes a reset transistor provided to be adjacent to said charge detecting portion for returning the potential of said charge detecting portion to an initial value,
said charge detecting portion includes a first charge detecting portion provided to be adjacent to said charge transfer region and a second charge detecting portion constituting one of source/drain regions of said reset transistor, and
said first insulating film is formed on the surface of said first charge detecting portion, while said second insulating film is formed on the surface of said second charge detecting portion.

8. The image sensor according to claim 7, wherein
said first charge detecting portion and said second charge detecting portion are electrically connected with each other.

9. The image sensor according to claim 1, provided with a plurality of pixels each including at least said charge transfer region, said transfer electrode and an increasing electrode formed on said increasing portion through said first insulating film.

10. The image sensor according to claim 9, wherein
each of said plurality of pixels includes a reset transistor provided to be adjacent to a charge detecting portion for detecting said signal charge as voltage for returning the potential of said charge detecting portion to an initial value, an amplifier transistor for amplifying said voltage detected by said charge detecting portion and a selection transistor for outputting said voltage detected by said charge detecting portion from selected said pixel, and
said transistor includes said reset transistor, said amplifier transistor and said selection transistor.

11. The image sensor according to claim 10, wherein
said second insulating film constitutes a gate insulating film of each of said reset transistor, said amplifier transistor and said selection transistor.

12. The image sensor according to claim 9, further comprising a peripheral circuit region provided on the periphery of an imaging region on which said plurality of pixels are arranged, wherein
said transistor includes a peripheral circuit transistor provided on said peripheral circuit region.

13. The image sensor according to claim 12, wherein
said second insulating film constitutes a gate insulating film of said peripheral circuit transistor.

14. The image sensor according to claim 1, further comprising a photoelectric conversion portion provided to be adjacent to said charge transfer region for generating said signal charge, wherein
said second insulating film is provided on the surface of said photoelectric conversion portion.

15. The image sensor according to claim 14, wherein
the boundary between said first insulating film and said second insulating film is provided on a position substantially identical to the boundary between said photoelectric conversion portion and said charge transfer region.

16. The image sensor according to claim 1, further comprising an increasing electrode provided on the surface of said first insulating film to be adjacent to said transfer electrode, wherein
said increasing portion is provided on said charge transfer region located under said increasing electrode.

17. The image sensor according to claim 16, further comprising a charge detecting portion for detecting said signal charge as voltage, wherein
said transfer electrode includes a read electrode provided on the surface of a region of said first insulating film corresponding to a portion of said increasing electrode closer to said charge detecting portion.

18. The image sensor according to claim 17, further comprising a photoelectric conversion portion provided on a side of said charge transfer region opposite to said charge detecting portion for generating said signal charge, wherein
said transfer electrode includes a first transfer electrode provided on the surface of a region of said first insulating film corresponding to a portion of said increasing electrode closer to said photoelectric conversion portion as well as a second transfer electrode and a storage electrode provided on the surface of a region of said first insulating film corresponding to a space between said increasing electrode and said read electrode.

19. The image sensor according to claim 1, wherein
said first insulating film and said second insulating film are provided to be adjacent to each other, and
the thickness of said first insulating film is gradually reduced toward a portion where said first insulating film and said second insulating film are in contact with each other.

20. The image sensor according to claim 19, further comprising a charge detecting portion for detecting said signal charge as voltage, wherein
a portion of said first insulating film whose thickness is gradually reduced is a region corresponding to a portion of said first insulating film located on said charge detecting portion.
